(19) United States
(12) Patent Application Publication
(10) Pub. No.: US 2011/0205913 A1
(43) Pub. Date: Aug. 25, 2011

(54) BEAMFORMING AND SDMA METHODS FOR WIRELESS LAN AND OTHER APPLICATIONS

(75) Inventors: Albert Van Zelst, Woerden (NL); Didier Johannes Richard Van Nee, De Meern (NL); Geert Arnout Awater, Utrecht (NL)

(73) Assignee: QUALCOMM INCORPORATED, San Diego, CA (US)

(21) Appl. No.: 12/710,728

(22) Filed: Feb. 23, 2010

(51) Int. Cl. H04W 4/00; H04L 12/26

(52) U.S. Cl. 370/252; 370/338

(57) ABSTRACT

Embodiments of the present disclosure present methods for calculating beamforming and spatial division multiple access (SDMA) weights utilizing minimum mean square error (MMSE) method. The beamforming and SDMA weights may also be normalized for further performance improvements.

### TECHNICAL FIELD

Certain embodiments of the present disclosure generally relate to wireless communications and, more particularly, to wireless communications utilizing beamforming or spatial division multiple access (SDMA) techniques.

### BACKGROUND

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has recently emerged as a popular technique for the next generation communication systems. MIMO technology has been adopted in several emerging wireless communications standards such as the Institute of Electrical and Electronics Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters).

A MIMO wireless system employs a number (N_{T}) of transmit antennas and a number (N_{R}) of receive antennas for data transmission. A MIMO channel formed by the N_{T} transmit and N_{R} receive antennas may be decomposed into N_{S} spatial streams, where, for all practical purposes, N_{S}<=min{N_{T},N_{R}}. The N_{S} spatial streams may be used to transmit N_{S} independent data streams to achieve greater overall throughput.

Beamforming and spatial division multiple access (SDMA) techniques may be used in MIMO communication systems to further enhance spectral efficiency, particularly when stations support less spatial streams than the access point.

### SUMMARY

Certain embodiments of the present disclosure provide a method for wireless communications. The method generally includes estimating a channel matrix corresponding to a channel between a transmitter and a receiver, selecting one or more spatial dimensions of the channel matrix so that number of spatial streams assigned to the receiver is less than number of receive antennas at the receiver, calculating one or more beamforming weights based on the selected spatial dimensions, and transmitting to the receiver using the beamforming weights.

Certain embodiments of the present disclosure provide a method for wireless communications. The method generally includes estimating one or more channel matrices corresponding to channels between a transmitter and one or more receivers, calculating one or more spatial division multiple access (SDMA) weights utilizing the channel matrices, normalizing the SDMA weights, and transmitting to the receivers using the SDMA weights.

Certain embodiments of the present disclosure provide a method for wireless communications. The method generally includes estimating one or more channel matrices corresponding to channels between a transmitter and one or more receivers, selecting one or more spatial dimensions of the channel matrices so that number of spatial streams assigned to the receivers corresponding to the channel matrices are less than number of receive antennas at the receivers, calculating one or more spatial division multiple access (SDMA) weights based on the selected spatial dimensions, and transmitting to the receivers using the SDMA weights.

Certain embodiments of the present disclosure provide an apparatus for wireless communications. The apparatus generally includes logic for estimating a channel matrix corresponding to a channel between a transmitter and a receiver, logic for selecting one or more spatial dimensions of the channel matrix so that number of spatial streams assigned to the receiver is less than number of receive antennas at the receiver, logic for calculating one or more beamforming weights based on the selected spatial dimensions, and logic for transmitting to the receiver using the beamforming weights.

Certain embodiments of the present disclosure provide an apparatus for wireless communications. The apparatus generally includes logic for estimating one or more channel matrices corresponding to channels between a transmitter and one or more receivers, logic for calculating one or more spatial division multiple access (SDMA) weights utilizing the channel matrices, logic for normalizing the SDMA weights, and logic for transmitting to the receivers using the SDMA weights.

Certain embodiments of the present disclosure provide an apparatus for wireless communications. The apparatus generally includes logic for estimating one or more channel matrices corresponding to channels between a transmitter and one or more receivers, logic for selecting one or more spatial dimensions of the channel matrices so that number of spatial streams assigned to the receivers corresponding to the channel matrices are less than number of receive antennas at the receivers, logic for calculating one or more spatial division multiple access (SDMA) weights based on the selected spatial dimensions, and logic for transmitting to the receivers using the SDMA weights.

Certain embodiments of the present disclosure provide an apparatus for wireless communications. The apparatus generally includes means for estimating a channel matrix corresponding to a channel between a transmitter and a receiver, means for selecting one or more spatial dimensions of the channel matrix so that number of spatial streams assigned to the receiver is less than number of receive antennas at the receiver, means for calculating one or more beamforming weights based on the selected spatial dimensions, and means for transmitting to the receiver using the beamforming weights.

Certain embodiments of the present disclosure provide an apparatus for wireless communications. The apparatus generally includes means for estimating one or more channel matrices corresponding to channels between a transmitter and one or more receivers, means for calculating one or more spatial division multiple access (SDMA) weights utilizing the channel matrices, means for normalizing the SDMA weights, and means for transmitting to the receivers using the SDMA weights.

Certain embodiments of the present disclosure provide an apparatus for wireless communications. The apparatus generally includes means for estimating one or more channel matrices corresponding to channels between a transmitter and one or more receivers, means for selecting one or more spatial dimensions of the channel matrices so that number of spatial streams assigned to the receivers corresponding to the channel matrices are less than number of receive antennas at the receivers, means for calculating one or more spatial division multiple access (SDMA) weights based on the selected spatial dimensions, and means for transmitting to the receivers using the SDMA weights.

Certain embodiments of the present disclosure provide a computer-program product for wireless communications, comprising a computer-readable medium having instructions stored thereon, the instructions being executable by one or more processors. The instructions generally include instructions for estimating a channel matrix corresponding to a channel between a transmitter and a receiver, instructions for selecting one or more spatial dimensions of the channel matrix so that number of spatial streams assigned to the receiver is less than number of receive antennas at the receiver, instructions for calculating one or more beamforming weights based on the selected spatial dimensions, and instructions for transmitting to the receiver using the beamforming weights.

Certain embodiments of the present disclosure provide a computer-program product for wireless communications, comprising a computer-readable medium having instructions stored thereon, the instructions being executable by one or more processors. The instructions generally include instructions for estimating one or more channel matrices corresponding to channels between a transmitter and one or more receivers, instructions for calculating one or more spatial division multiple access (SDMA) weights utilizing the channel matrices, instructions for normalizing the SDMA weights, and instructions for transmitting to the receivers using the SDMA weights.

Certain embodiments of the present disclosure provide a computer-program product for wireless communications, comprising a computer-readable medium having instructions stored thereon, the instructions being executable by one or more processors. The instructions generally include instructions for estimating one or more channel matrices corresponding to channels between a transmitter and one or more receivers, instructions for selecting one or more spatial dimensions of the channel matrices so that number of spatial streams assigned to the receivers corresponding to the channel matrices are less than number of receive antennas at the receivers, instructions for calculating one or more spatial division multiple access (SDMA) weights based on the selected spatial dimensions, and instructions for transmitting to the receivers using the SDMA weights.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates an example transmitter that utilizes beamforming to transmit a signal to a destination, in accordance with certain embodiments of the present disclosure.

FIG. 5 illustrates example operations for generating beamforming weights, in accordance with certain embodiments of the present disclosure.

FIG. 5A illustrates example components capable of performing the operations illustrated in FIG. 5.

FIG. 6 illustrates an example transmitter that utilizes spatial division multiple access (SDMA) to transmit a plurality of signals to one or more destinations, in accordance with certain embodiments of the present disclosure.

FIG. 7 illustrates example operations for generating SDMA weights, in accordance with certain embodiments of the present disclosure.

FIG. 7A illustrates example components capable of performing the operations illustrated in FIG. 7.

FIG. 8 illustrates example operations for an alternative method for generating SDMA weights, in accordance with certain embodiments of the present disclosure.

FIG. 8A illustrates example components capable of performing the operations illustrated in FIG. 8.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects. Also as used herein, the term “legacy stations” generally refers to wireless network nodes that operate in compliance with 802.11n or earlier versions of the IEEE 802.11 standard.

The multi-antenna transmission techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement IEEE 802.11 or some other standards. A TDMA system may implement GSM or some other standards. These various standards are known in the art.

### An Example MIMO System

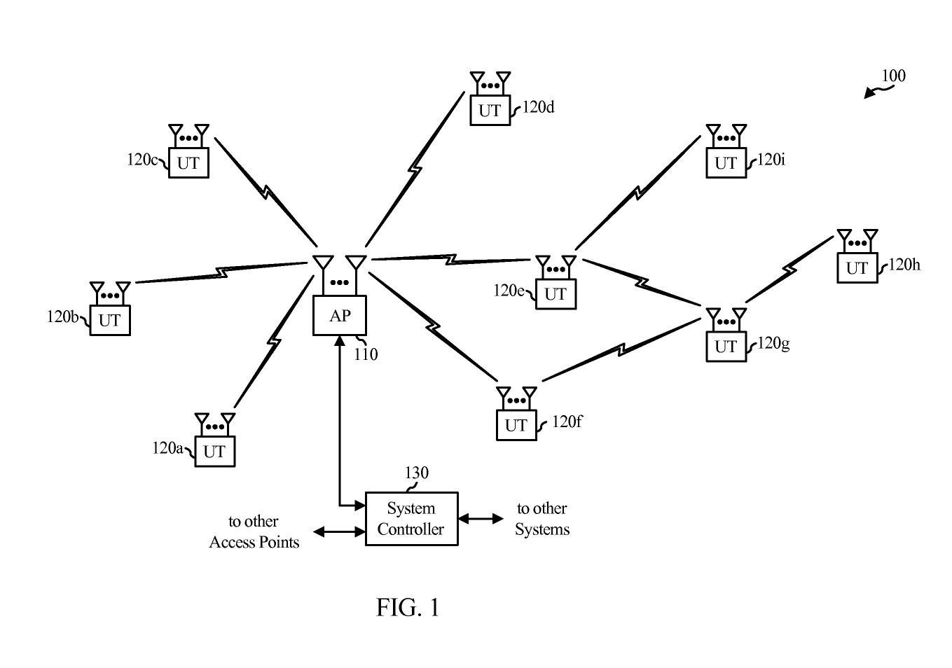

FIG. 1 illustrates a multiple-access MIMO system 100 with access points and user terminals. For simplicity, only one access point 110 is shown in FIG. 1. An access point (AP) is generally a fixed station that communicates with the user terminals and may also be referred to as a base station or some other terminology. A user terminal may be fixed or mobile and may also be referred to as a mobile station, a station (STA), a client, a wireless device, or some other terminology. A user terminal may be a wireless device, such as a cellular phone, a personal digital assistant (PDA), a handheld device, a wireless modem, a laptop computer, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. In certain cases, it may be desirable to have Nₐₚ≧Nᵤ≧1 if the data symbol streams for the Nᵤ user terminals are not multiplexed in code, frequency, or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

MIMO system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported).

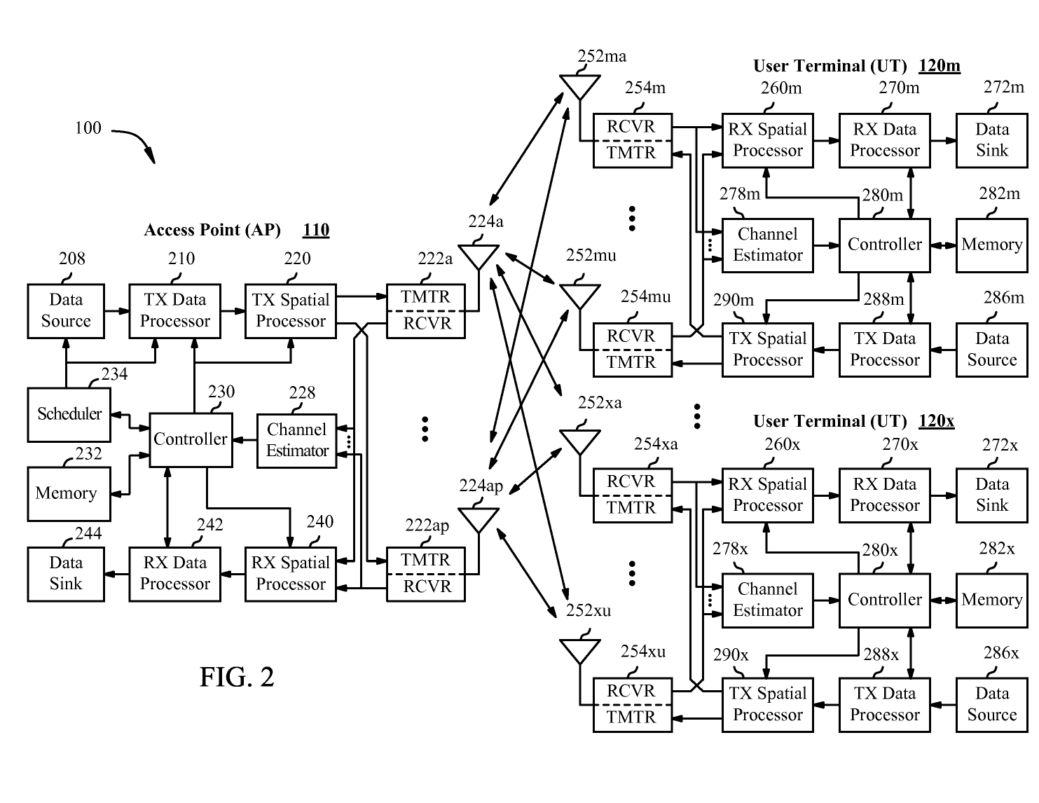

FIG. 2 shows a block diagram of access point 110 and two user terminals 120m and 120x in MIMO system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal. An RX data processor 242 processes (e.g., demodulates, deinterleaves, and decodes) each recovered uplink data symbol stream {s_{up,m}} in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal. The receiver spatial processing is performed in accordance with the CCMI, MMSE, or some other technique. An RX data processor 270 processes (e.g., demodulates, deinterleaves, and decodes) the recovered downlink data symbol stream to obtain decoded data for the user terminal.

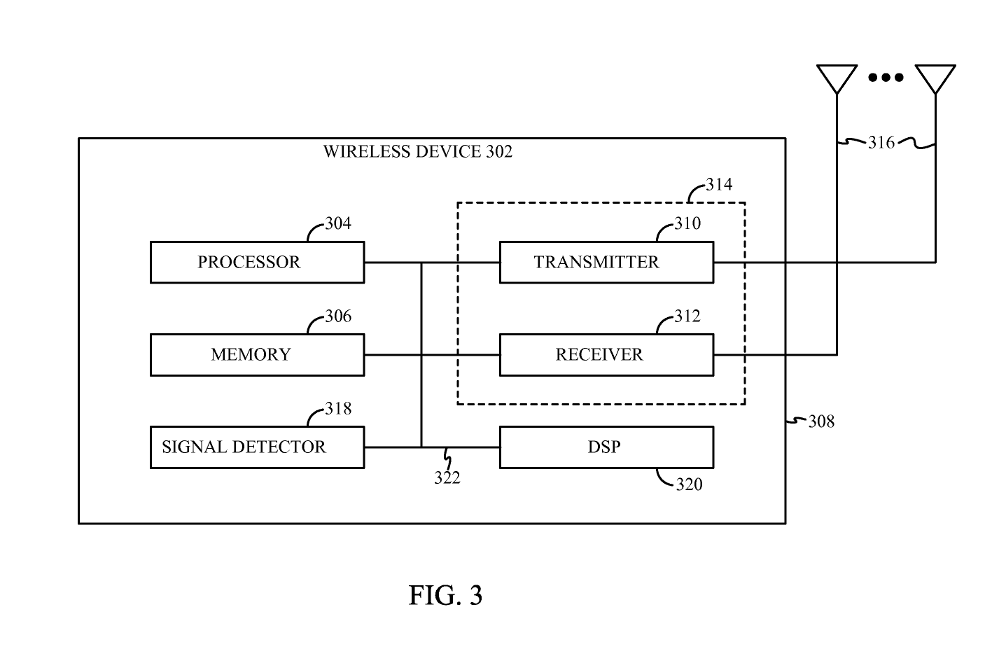

FIG. 3 illustrates various components that may be utilized in a wireless device 302 that may be employed within the system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

Certain embodiments of the present disclosure propose methods for calculating beamforming and SDMA weights for MIMO transmission based on the minimum mean square error (MMSE) algorithm or its variations. The methods may also include normalization of the calculated weights in order to improve system performance.

Beamforming and SDMA may be used in MIMO communication systems to further enhance spectral efficiency, particularly when stations support less spatial streams than the AP. In this disclosure, the term beamforming refers to beamed transmissions to a single destination (e.g., a station) at a time, to enhance the rate and/or range of transmission. Similarly, the term SDMA refers to beamed transmissions to two or more destinations at the same time, particularly to enhance the network throughput when individual transmissions to each of the destinations are rate limited.

To perform beamforming or SDMA from a source to one or more destinations, a forward link channel (i.e., the channel between the source and the destination) needs to be known at the source. This channel knowledge may be obtained either explicitly or implicitly. In the explicit method, the source sends a channel training sequence with proper spatial dimensions to the destinations that are targets of beamforming or SDMA transmissions. The destinations estimate the forward link channel based on the received training sequence. Once the channel is estimated, the destinations send the estimated forward link channel metrics to the source.

For beamforming or SDMA based on an implicit channel estimation method, the forward link channel is implicitly determined by observing the reverse link channel at the source. Estimate of the reverse link channel is transposed and, when necessary, corrected for any relative gain and phase differences in each receive and transmit chain pair to generate an estimate of the forward link channel. The relative gain and phase differences may be estimated through calibration. The implicit method requires equal number of transmit and receive chains at the source.

One of the advantages of the explicit channel estimation method is that the source may have unequal number of transmit and receive chains. On the other hand, in the implicit channel estimation method, equal number of transmit and receive chains should be present at the source. A further advantage of the explicit method over the implicit channel estimation method is that the source does not need to calibrate gains and phases of its receive versus transmit chains.

For subcarrier n, H_{reverse link}(n) may represent a reverse link channel for a destination to beamform to, or to perform an SDMA transmission to. H_{reverse link}(n) may consist of Nₜₓ×Nᵣₓ complex elements, in which Nₜₓ is the number of transmit antennas at the source and Nᵣₓ is the number of receive antennas at the destination. As mentioned before, for implicit method, Nₜₓ=Nᵣₓ. The forward link channel H(n) may be estimated implicitly as follows:

H(n)=H_{reverse link}^{T}(n)C(n), (1)

where C(n) is a diagonal matrix with complex elements that corrects relative gain and phase differences in each receive and transmit chain pair for subcarrier n. The gain differences may also include relative differences in the gain settings of each receive chain when H_{reverse link}(n) is observed.

For explicit feedback of the channel state information, the forward link channel H(n) is measured at the destination to generate a channel estimation metric. The channel estimation metric is transmitted to the source. The source may use the metric without phase or amplitude correction.

For beamforming, forward link channel H(n) is utilized to calculate the beamforming weights. Similarly, in SDMA, a composite forward link channel is formed by stacking the forward link channels of different destinations that are part of the SDMA transmission.

Note that for the SDMA methods described in this document, the number of beamed streams to a destination is assumed to be equal to the number of receive antennas at the destination. The reason is that if a receive antenna is not considered in the SDMA weight calculation, during the SDMA transmission, this receive antenna receives interference from all the data streams. Hence, the maximum number of spatial streams the destination may support is equal to its number of active receive antennas.

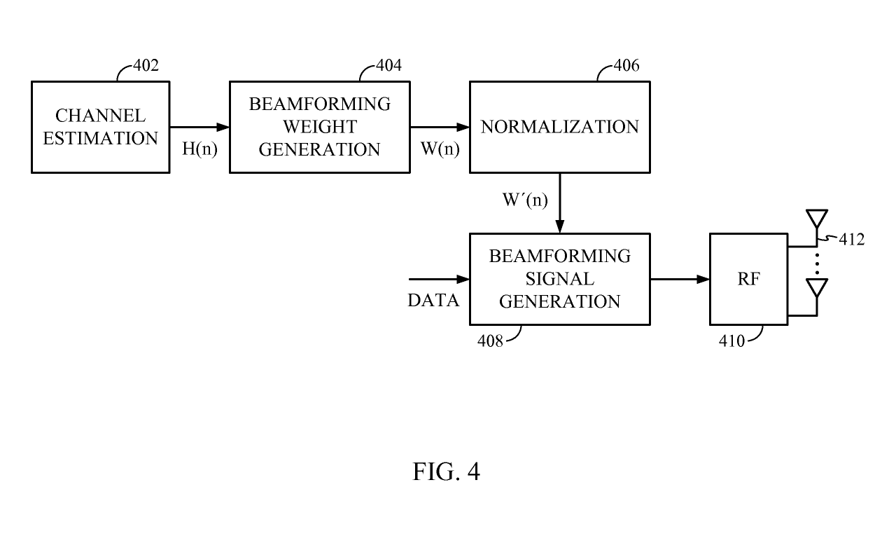

FIG. 4 illustrates an example transmitter that utilizes beamforming to transmit a signal to a destination, in accordance with certain embodiments of the present disclosure. The transmitter may obtain or estimate the forward channel H(n) either explicitly or implicitly in block 402. The estimated channel matrix may be passed to the beamforming weight generation 404. The beamforming weight generation block calculates the beamforming weights W(n) according to one of the methods described in the Equations (2, 5) or (14-22).

The beamforming weights W(n) may optionally be passed to a normalization 406 block to be normalized based on one of the proposed normalization methods presented in this disclosure. Normalization may be performed on the beamforming weights to improve system performance according to one of the Equations (10), (12), (13) or (23-30). The beamforming weights may then enter a beamforming signal generation block 408 that transforms a data-bearing signal to a beamformed signal. The beamformed signal may then be up-converted to a desired transmit frequency band by a radio frequency (RF) front end 410. Antennas 412 may then transmit the signal over the wireless channel.

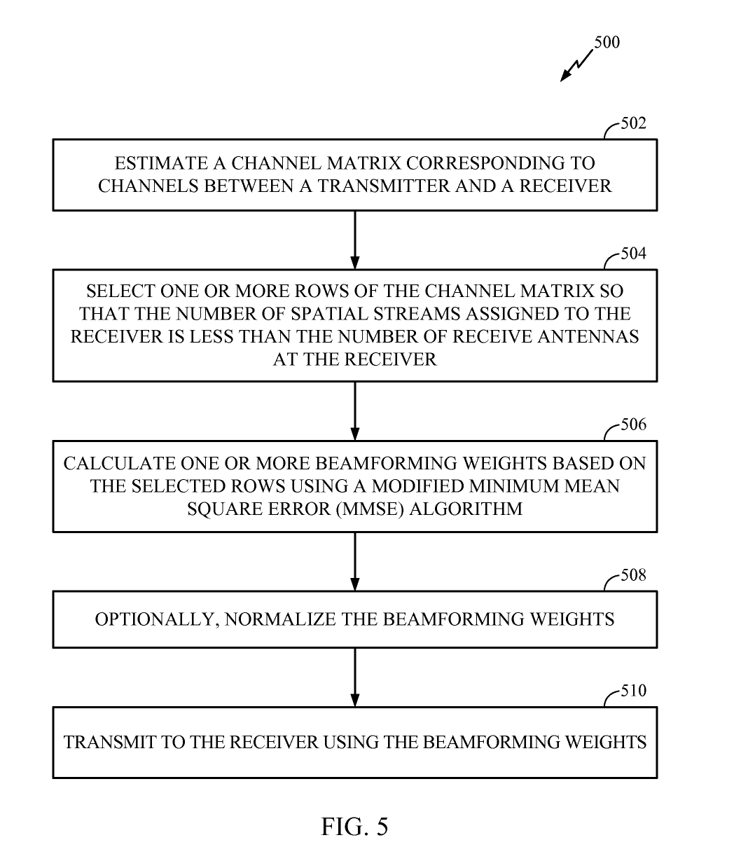

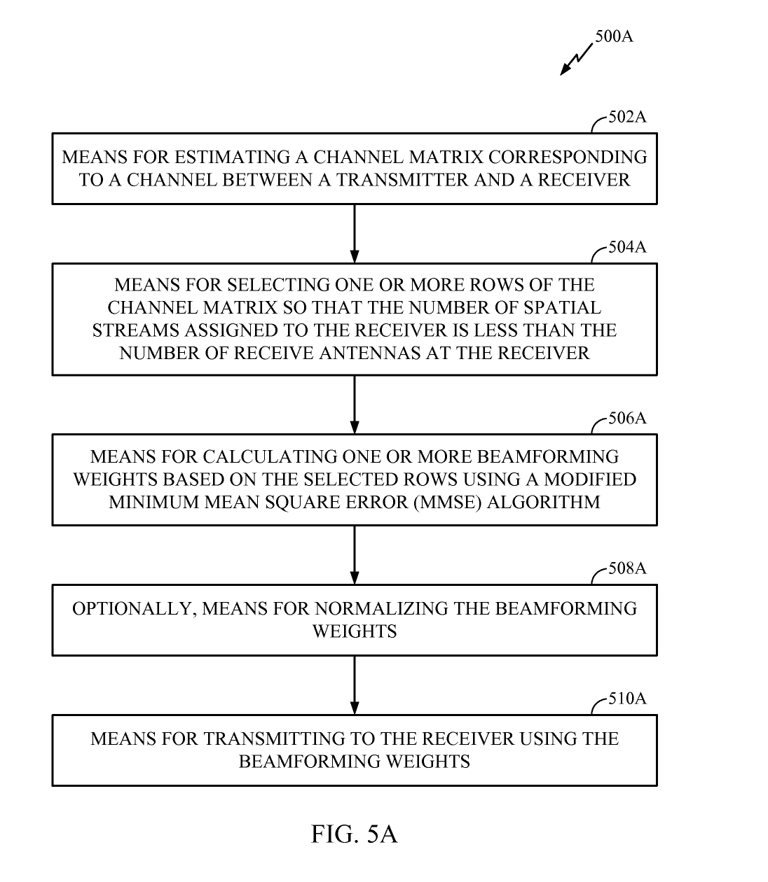

FIG. 5 illustrates example operations 500 for generating beamforming weights, in accordance with certain embodiments of the present disclosure. At 502, the transmitter estimates a channel matrix corresponding to a channel between a transmitter and a receiver. At 504, the transmitter selects one or more spatial dimensions (i.e., rows) of the channel matrix so that number of spatial streams assigned to the receiver is less than number of receive antennas at the receiver.

At 506, the transmitter calculates one or more beamforming weights based on the selected spatial dimensions, using for example, a minimum mean square error (MMSE) algorithm. At 508, the transmitter may normalize the beamforming weights for further performance improvements. At 510, the transmitter transmits to the receiver using the beamforming weights.

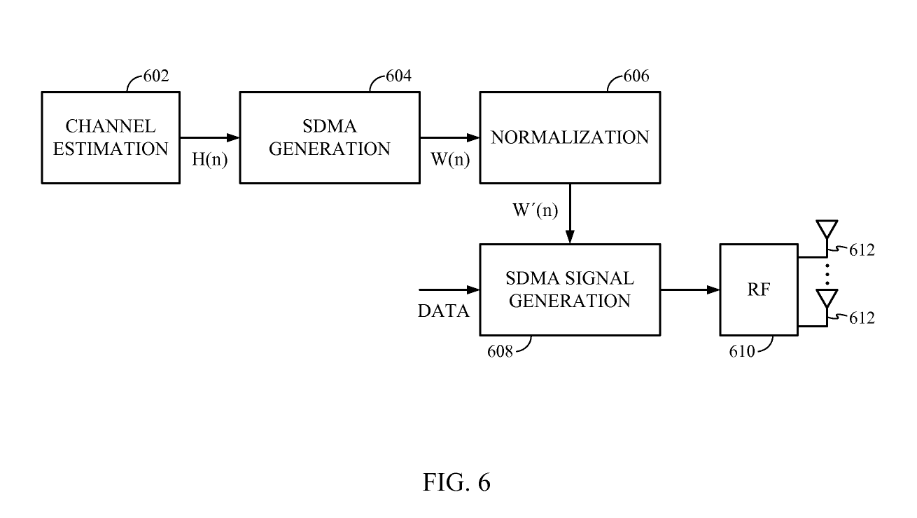

FIG. 6 illustrates an example transmitter that utilizes SDMA to transmit a plurality of signals to one or more destinations, in accordance with certain embodiments of the present disclosure. Similar to the transmitter in FIG. 4 that was performing beamforming, the transmitter may obtain or estimate the forward channel H(n) either explicitly or implicitly in block 602. The estimated channel matrix may be forwarded to the SDMA weight generation 604. The SDMA weight generation block calculates the SDMA weights W(n) according to Equations (7-8) or (21-22).

The SDMA weights W(n) may optionally be passed to a normalization 606 block to be normalized. Normalization may be performed on the SDMA weights to improve system performance according to one of the Equations (10), (12), (13) or (23-30). The SDMA weights may then enter a SDMA signal generation block 608 that transforms a data-bearing signal to an SDMA signal. The SDMA signal may then be up-converted to a desired transmit frequency band by a radio frequency (RF) front end 610. Antennas 612 may then transmit the SDMA signal over the wireless channel.

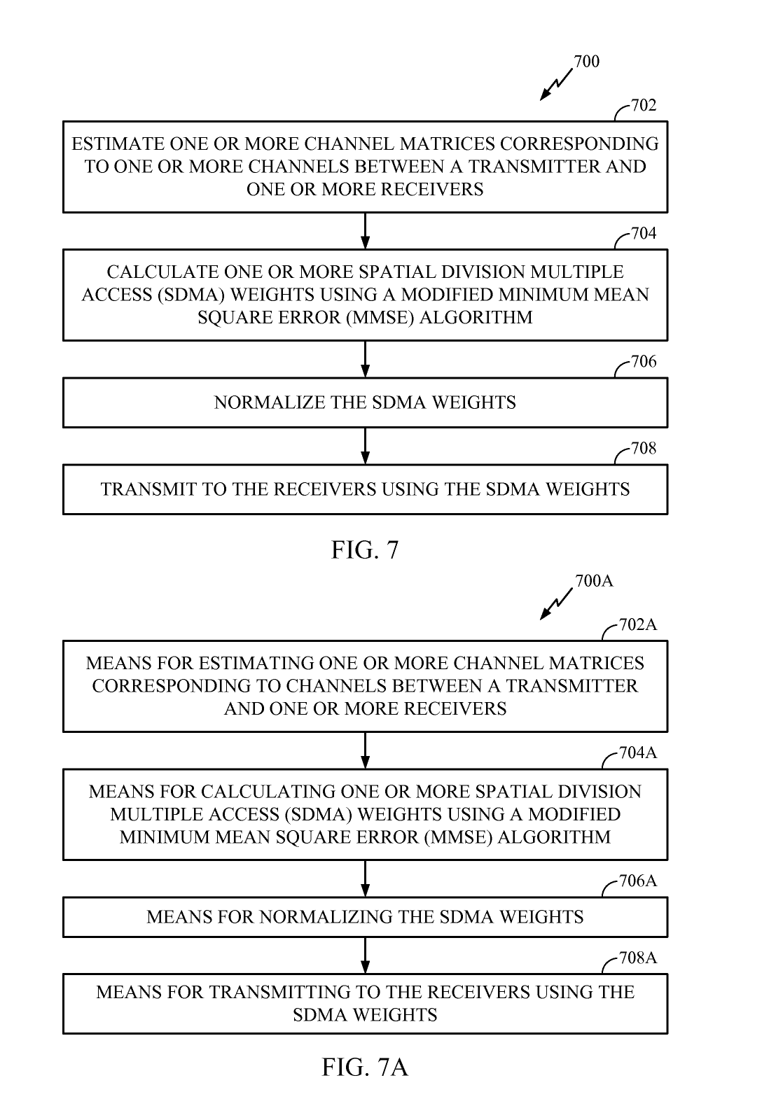

FIG. 7 illustrates example operations 700 for generating SDMA weights, in accordance with certain embodiments of the present disclosure. At 702, the transmitter obtains or estimates a channel matrix corresponding to channels between a transmitter and one or more receivers. The channel estimate may be obtained explicitly or implicitly. At 704, the transmitter calculates one or more SDMA weights using the channel matrices and utilizing an MMSE algorithm. At 706, the transmitter may normalize the SDMA weights to enhance performance. At 708, the transmitter transmits data-bearing signals to the receivers using the SDMA weights.

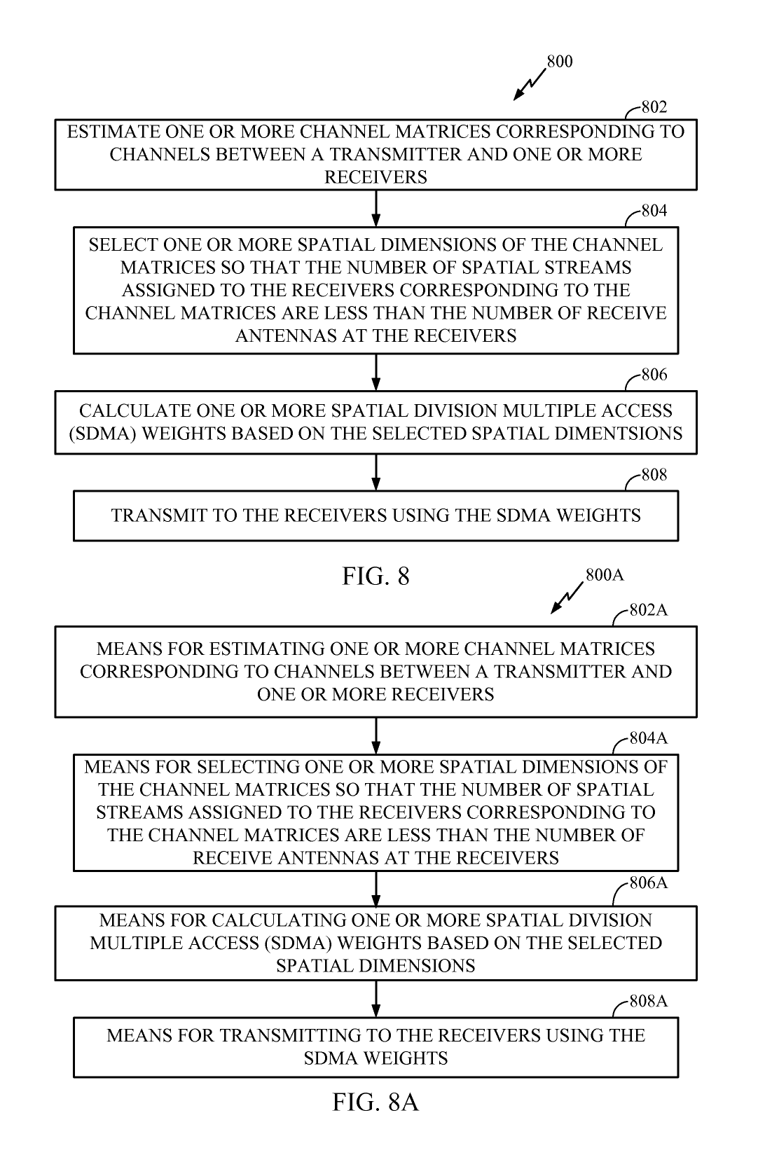

FIG. 8 illustrates example operations 800 for an alternative method for generating SDMA weights, in accordance with certain embodiments of the present disclosure. At 802, the transmitter estimates one or more channel matrices corresponding to channels between a transmitter and one or more receivers. At 804, the transmitter selects one or more spatial dimensions of the channel matrices so that the number of spatial streams assigned to the receivers corresponding to the channel matrices is less than the number of receive antennas at the receivers. At 806, the transmitter calculates one or more SDMA weights based on the selected spatial dimensions. At 806, the transmitter transmits to the receivers using the SDMA weights.

### Mathematical Description of the Proposed Methods

### Beamforming

For certain aspects of the present disclosure, a beamforming algorithm is proposed based on the minimum mean square error (MMSE) algorithm. MMSE beamforming weights W(n) may be calculated as follows:

W(n)=H^{H}(n)(αI_{N}_{ᵣₓ}+H(n)H^{H}(n))⁻¹, (2)

where α is a scalar based on the received SNR, I_{Nrx} is an Nᵣₓ×Nᵣₓ identity matrix, Nᵣₓ is number of receive antennas at the destination, and H^{H}(n) represents Hermitian of the channel matrix H(n).

When number of spatial streams Nₛₛ is less than the number of receive antennas Nᵣₓ, the source can choose to select a subset of receive antennas of the destination to beamform to, assuming that the receive antennas that are not selected are able to tolerate a potentially longer channel impulse response.

For certain embodiments, the receive antennas may be selected based on average power in the channel to each receive antenna. Power p_{q}(n) of the q^{th} row of the channel matrix H(n) may be written as follows:

p_{q}(n)=|h_{q1}(n)|²+ . . . +|h_{qN}_{ₜ}(n)|², (3)

where h_{qt}(n) represents element (q,t) of H(n). When H(n) is available for N_{c} subcarriers, the average channel gain P_{q} for the q^{th} receive antenna may be written as follows:

$${p}_{q} = {\sum }_{n = 1}^{{N}_{c}} {p}_{q} ( n ) \qquad ( 4 )$$

For certain embodiments, Nₛₛ receive antennas with the best average channel gain may be selected, and the corresponding rows of H(n) may be used in the MMSE beamforming weight calculation. As an example, the first Nₛₛ rows of H(n) may have the best average channel gain, therefore, the beamforming weights W(n) may be calculated as follows:

W(n)=Hₛ^{H}(n)(αI_{N}_{ₛₛ}+Hₛ(n)Hₛ^{H}(n))⁻¹. (5)

where Hₛ(n) represents the first Nₛₛ rows of H(n).

The above method is called Average Receive Selection based on Power (ARSP), or, in a complete form, MMSE ARSP beamforming. For certain embodiments, a variation on the ARSP method may calculate log₂ (p_{q}(n)) and use the sum over frequency of the logarithm values to select the best Nₛₛ receive antennas.

For certain embodiments, if the MMSE ARSP beamforming technique results in more packet errors than transmissions without beamforming (i.e., open-loop transmissions), it may have one of the following two reasons. First, a Maximum-Likelihood (ML) detector, or near-ML detector may have been used at the receiver that can be shown to perform better when beamforming is not used (e.g., for equal modulation and a number of spatial streams close to or equal to the number of transmit antennas). Therefore, in case of an ML-like detector at the receiver, by disabling beamforming and changing to open-loop transmission, the performance may be improved.

The second reason for high packet errors may be that the receive antennas of the destination that are not selected for beamforming, may not be able to tolerate the longer channel impulse responses. For certain embodiments, the problem may be solved by calculating the beamforming weights based on the complete channel estimation matrix H(n) and spatially expand the Nₛₛ data streams to the Nᵣₓ links available in the channel. This technique is called MMSE Copy (CP) beamforming.

For certain embodiments, in the MMSE Copy beamforming method, the following expansion matrices can be used to expand from one spatial stream to two links available in the channel (1 to 2), 1 to 3, 1 to 4, 2 to 3, 2 to 4, and 3 to 4, respectively:

$$E = ( \begin{matrix}1 \\ 1\end{matrix} ) , ( \begin{matrix}1 \\ 1 \\ 1\end{matrix} ) , ( \begin{matrix}1 \\ 1 \\ 1 \\ 1\end{matrix} ) , ( \begin{matrix}1 & 0 \\ 0 & 1 \\ \frac{1}{2} \sqrt{2} & \frac{1}{2} \sqrt{2}\end{matrix} ) , ( \begin{matrix}1 & 0 \\ 0 & 1 \\ 1 & 0 \\ 0 & 1\end{matrix} ) , \\ and ( \begin{matrix}1 & 0 & 0 \\ 0 & 1 & 0 \\ 0 & 0 & 1 \\ \frac{1}{3} \sqrt{3} & \frac{1}{3} \sqrt{3} & \frac{1}{3} \sqrt{3}\end{matrix} ) . \qquad ( 6 )$$

So, for MMSE CP beamforming (i.e., in case of spatial expansion with MMSE beamforming), the beamforming weights W′(n) may be calculated by multiplying the beamforming weights with matrix E, therefore, W′(n)=W(n).E.

### SDMA

For certain embodiments, an SDMA algorithm is proposed that uses MMSE weights. The MMSE SDMA weights may be calculated as follows:

W(n)=H^{H}(n)(αI_{N}_{_{rx,tot}}+H(n)H^{H}(n))⁻¹, (7)

where H(n) is the composite forward link channel formed by stacking the forward link channels of the different destinations that are part of the SDMA transmission and N_{rx,tot} is the total number of known receive antennas of the destinations.

Note that, for most of the SDMA methods described in this document, it is assumed that the number of streams beamed to a destination is equal to the number of receive antennas of the destination, otherwise, if a receive antenna is not considered in the SDMA weight computation, during the SDMA transmission this receive antenna may see interference from all of the data streams. Unless the destination performs interference cancellation/multi-user detection, this interference could result in unsuccessful packet reception.

When Nₛₛ<Nᵣₓ for a given destination, spatial expansion to that destination should be used by utilizing the E matrices specified in Eqn (6). For example, if H(n) consists of a 4×2 channel to a first destination, a 4×1 channel to a second destination, and only one spatial stream is to be sent to each of the destinations, the 2 spatial streams are mapped to the three dimensions supported by W(n) in this case using the following mapping:

$${E}_{tot} = ( \begin{matrix}1 & 0 \\ 1 & 0 \\ 0 & 1\end{matrix} ) , \qquad ( 8 )$$

therefore, the SDMA weights become W(n)Eₜₒₜ.

For certain embodiments of the present disclosure, antenna selection may be performed in SDMA. In this case, the receiver may utilize interference suppression, interference cancellation, or multi-user detection to suppress or cancel the interference from other streams and still get a reasonable performance. For example, a transmitter may select one or more rows of the channel matrix corresponding to a receiver (i.e., select one or more receive antennas of the receiver), or one or more eigenvectors of the channel matrix, and calculate the SDMA weights based on the selected rows or eigenvectors, using the MMSE algorithm.

The transmitter may also use all of the rows in the channel matrices of other SDMA receivers. The transmitter may then send a signal to the plurality of receivers using the calculated SDMA weights. The receivers for which the number of selected rows (hence the number of spatial streams) are less than the number of receive antennas, may use a interference suppression, multi-user detection, or interference cancellation method to decode the transmitted data.

When using SDMA, a mechanism should be present in the transmitter to be able to detect if high percentage of packets are received in error or not, even for lower rates. In that case, the transmitter should stop using SDMA to the destination that is responsible for the high Packet Error Rate (PER). The destination may have more active receive antennas than the number of spatial steams assigned to it, or the destination could use more receive antennas than the number of receive dimensions available in the channel estimate at the transmitter.

For certain embodiments, one method to determine the PER for each destination is to check the acknowledgment rate for the packets sent to each destination. Alternatively the number of receive antennas could be communicated or negotiated between receiver and transmitter before the SDMA link is set up.

### Flexible Per-Subcarrier Normalization

For certain embodiments, performance of a system utilizing beamforming or SDMA may be improved by normalizing the beamforming or SDMA weights, using Flexible Per-Subcarrier Normalization (FPSN) method.

The FPSN method may be performed by selecting a preferred output power P_{pref} and determining average power P of the beamforming/SDMA weights over all subcarriers, as follows:

$$P = \frac{1}{{N}_{c} {N}_{tx}} {\sum }_{n = 1}^{{N}_{c}} {\sum }_{p = 1}^{{N}_{tx}} {\sum }_{q = 1}^{{N}_{ss}} {\vert {w}_{pq} ( n ) \vert}^{2} , \qquad ( 9 )$$

where w_{pq} (n) represents the element on the p^{th} row and q^{th} column of matrix W(n).

The beamforming/SDMA weights may then be normalized per subcarrier using the following equation:

$${W}^{′} ( n ) = \frac{\sqrt{{P}_{pref}}}{\sqrt{β P + \frac{1 - β}{{N}_{tx}} {\sum }_{p = 1}^{{N}_{tx}} {\sum }_{q = 1}^{{N}_{ss}} {\vert {w}_{pq} ( n ) \vert}^{2}}} W ( n ) , \qquad ( 10 )$$

where β is a constant, β=0 represents pure Per-Subcarrier Normalization (PSN) and β=1 represents overall normalization of all the tones to a preferred output level.

For certain embodiment, without significant performance degradation, the inverse square root (1/\sqrt{x}) operation in Eqn (10) can be approximated by 2^{-approxlog(x)/2}, where the multiplication by 2^{-y} may be implemented as an arithmetic shift to the right by floor(y) bits, combined with some multiplication factor to represent the fractional bits in y. The division by 2 is an arithmetic shift to the right by one bit, and an approxlog function may be implemented with less complexity than the complexity of an inverse square root lookup table.

For certain embodiments, in order to make sure that a power amplifier of a given transmit chain does not saturate, the beamforming/SDMA weights W′(n) may further be normalized by the power of its strongest transmission. The average power over all subcarriers of the p^{th} row of W′(n), corresponding to the p^{th} transmitter, may be defined as follows:

$$s ( p ) = \frac{1}{{N}_{c}} {\sum }_{n = 1}^{{N}_{c}} {\sum }_{q = 1}^{{N}_{ss}} {\vert {w}_{pq}^{′} ( n ) \vert}^{2} , \qquad ( 11 )$$

and the weights may be normalized as follows:

$${W}^{″} ( n ) = \frac{{W}^{′} ( n )}{{max}_{p} s ( p )} . \qquad ( 12 )$$

For certain embodiments, normalization may be performed for each transmit antenna, which is particularly of interest for improving the link budget in case of beamforming. Therefore, normalized weights per transmit antenna may be written as follows:

$${w}_{pq}^{″} ( n ) = \frac{\sqrt{{P}_{pref}}}{\sqrt{s ( p )}} {w}_{pq} ( n ) . \qquad ( 13 )$$

### Beamforming Alternatives

A few alternative beamforming methods are proposed in this section. First, three alternatives for MMSE ARSP are described, for cases when Nₛₛ<Nᵣₓ. Then, singular value decomposition (SVD) MMSE is presented as alternative for MMSE beamforming.

For certain embodiments, an alternative for MMSE ARSP beamforming is an MMSE Average Receive Selection based on Capacity (MMSE ARSC) method. This algorithm consists of the following steps:

For each subcarrier and for all possible combinations of Nₛₛ rows out of the full-dimensional channel H(n), capacity may be calculated by utilizing the MMSE beamforming or normalized MMSE beamforming weights, as follows:

$$C ( n , s ) = {log}_{2} det ( {I}_{{N}_{ss}} + \frac{ρ}{{N}_{ss}} {H}^{′} ( n ) {H}^{′ H} ( n ) ) , \qquad ( 14 )$$

where H′(n)=Hₛ(n)Wₛ(n), and Hₛ(n) represents the rows of H for subset s, and Wₛ(n) is the corresponding (normalized) MMSE beamforming weight, and ρ is the expected received signal to noise ratio (SNR).

Sum C(s) of all the capacities C(n,s) over frequency for each subset s may be written as follows:

$$C ( s ) = {\sum }_{n = 1}^{{N}_{c}} C ( n , s ) \qquad ( 15 )$$

In the next step, Nₛₛ rows may be chosen from H(n) corresponding to the subset s with the highest capacity. Then, the (normalized) MMSE beamforming weights may be calculated for all subcarriers based on the selected rows of the full-dimensional channel matrices.

For certain embodiments of the present disclosure, a second proposed alternative for MMSE ARSP is MMSE Average Receive Selection based on the covariance matrix Q (MMSE ARSQ). This algorithm consists of the following steps:

For each subcarrier, covariance matrix Q(n) of the full-dimensional channel is calculated as follows:

Q(n)=(αI_{N}_{ₛₛ}+H(n)H^{H}(n))⁻¹. (16)

The covariance matrix Q(n) may be summed over frequency to generate Q as follows:

$$Q = {\sum }_{n = 1}^{{N}_{c}} Q ( n ) . \qquad ( 17 )$$

In the next step, N rows may be selected from H(n) corresponding to the lowest diagonal entries in Q. The (normalized) MMSE beamforming weights may then be calculated for all subcarriers based on the selected rows of the full-dimensional channel matrices. For certain embodiments, logarithm (e.g., in base two) of the covariance matrices Q(n) may be used in calculating the sum of covariance matrices, and lowest diagonal entries may be selected from the sum of logarithms of covariance matrices.

For certain embodiments of the present disclosure, a third proposed alternative for MMSE ARSP may be used that is called MMSE Optimal Receive Selection (MMSE ORS). This algorithm may consist of the following steps:

First, a covariance matrix Q(n) of the full-dimensional channel per subcarrier may be calculated as follows:

Q(n)=(αI_{N}_{ₛₛ}+H(n)H^{H}(n))⁻¹. (18)

For each subcarrier n, Nₛₛ rows from H(n) corresponding to the lowest diagonal entries in Q(n) may be chosen and MMSE beamforming weights may be calculated based on the reduced channel for subcarrier n.

For certain embodiments, in variations of MMSE ORS technique, the selection criteria may be the capacity per subset of Nₛₛ rows out of H(n), or the power per row of H(n). It should be noted that the capacity or power values are per subcarrier and are not averaged over frequency as in MMSE ARSC and MMSE ARSP methods, respectively.

For certain embodiments, an alternative to MMSE beamforming may be called SVD MMSE beamforming. The SVD MMSE beamforming method uses MMSE on the SVD of the channel estimates to equalize the channel. Using this method, the SVD of H(n), H(n)=U(n)D(n)V^{H}(n), is inverted and used as the beamforming weight. A factor α may be added to prevent division by zero in the inversion process. The SVD MMSE beamforming for a square channel matrix H(n) results in the following beamforming matrix:

W(n)=V(n)D(n)(αI_{N}+D²(n))⁻¹U^{H}(n), (19)

where N=Nᵣₓ=Nₜₓ=Nₛₛ. It should be noted that in the above equation, the multiplication by U^{H}(n) is redundant. This multiplication may also be part of the composite channel observed by the destination and because U^{H}(n) is unitary, it will not change the channel properties as seen by the destination.

Generalizing the above beamforming matrix to a general Nₛₛ yields the following matrix:

W(n)=V_{1:N}_{ₛₛ}(n)D_{1:N}_{ₛₛ}_{,1:N}_{ₛₛ}(n)(αI_{N}_{ₛₛ}+D_{1:NN}_{ₛₛ}_{,1:N}_{ₛₛ}²(n))⁻¹. (20)

where the subscript 1:Nₛ, denotes the first Nₛₛ columns of the corresponding matrix and 1:Nₛₛ, 1:Nₛₛ denote the upper-left Nₛₛ×Nₛₛ elements of the corresponding matrix.

### SDMA Alternatives

For certain embodiments, an alternative method for calculating SDMA weights may be based on Block Diagonalization (BD) with MMSE equalization. The BD method may only cancel interference from other destinations, therefore, the BD method has less constraints than MMSE algorithm when a destination has multiple receive antennas.

The algorithm for BD with MMSE equalization may be performed as follows: A channel Hₖ(n) to destination k is generated by selecting Nᵣₓ(k) rows from H(n) that represent the destination k. The channel Hₖ(n) may be generated for all the destinations. H′ₖ(n), which represents the channel to all destinations except the destination k, may be generated by selecting the remaining N_{rx,tot}−Nᵣₓ(k) rows of H(n). The singular value decomposition algorithm may be performed on H′ₖ(n) to obtain H′ₖ(n)=U′(n)D′(n)V′^{H}(n). The last Nₜₓ−(N_{rx,tot}−Nᵣₓ(k)) columns of V′(n) may be selected to generate Vₙᵤₗₗ(n), which represents the null space of H′ₖ(n).

The singular value decomposition algorithm may again be performed on Hₖ(n)Vₙᵤₗₗ(n) to obtain Hₖ(n)Vₙᵤₗₗ(n)=U(n)D(n)V^{H}(n). Therefore, the columns corresponding to the destination k in SDMA weight matrix W(n) may be written as follows:

Wₖ(n)=Vₙᵤₗₗ(n)V_{1:N}_{ₛₛ}₍ₖ₎(n)D_{1:N}_{ₛₛ}_{(k),1:N}_{ₛₛ}₍ₖ₎(n)(αI_{N}_{ₛₛ}₍ₖ₎+D_{1:N}_{ₛₛ}_{(k),1:N}_{ₛₛ}₍ₖ₎²(n))⁻¹. (21)

Generally, in the literature, water-filling is used to maximize capacity, however, in the proposed scheme, an MMSE equalization factor is used that is equal to D_{1:Nss(k),1:Nss(k)}(n)(αI_{Nss(k)}+D²_{1:Nss(k),1:Nss(k)}(n))⁻¹. If the goal is to have a minimum SNR for a fixed maximum physical layer rate (e.g., 64-quadrature amplitude modulation (QAM), rate 5/6 on all spatial streams), the proposed spatial pre-equalization results in a better PER performance than the water-filling approach without spatial pre-equalization.

For certain embodiments, the columns of destination k in W(n) may be approximated, with a small performance loss, as follows:

Wₖ(n)=Vₙᵤₗₗ(n)V_{1:NN}_{ₛₛ}₍ₖ₎(n)(αI_{N}_{ₛₛ}₍ₖ₎+D_{1:N}_{ₛₛ}_{(k),1:N}_{ₛₛ}₍ₖ₎(n))⁻¹. (22)

### Normalization Alternatives

For certain embodiments, alternatives to the FPSN normalization technique (see Equations (9)-(13)) are presented in this section. The alternatives are Per-Subcarrier Normalization (PSN), Flexible Per-Receiver Per-Subcarrier Normalization (FPRPSN), Flexible Per-Receiver Normalization (FPRN), and Flexible Per-Transmitter Normalization (FPTN).

In the Per-Subcarrier Normalization (PSN) method, the beamforming/SDMA weights W(n) may be normalized per subcarrier as follows:

$${W}^{′} ( n ) = \frac{\sqrt{{P}_{pref}}}{\sqrt{\frac{1}{{N}_{tx}} {\sum }_{p = 1}^{{N}_{tx}} {\sum }_{q = 1}^{{N}_{ss}} {\vert {w}_{pq} ( n ) \vert}^{2}}} W ( n ) \qquad ( 23 )$$

where P_{pref} is a preferred power value. Note that this method is equal to the FPSN method with β=0.

In the Flexible Per-Receiver Per-Subcarrier Normalization (FPRPSN) method, average power per receiver and per subcarrier over frequency is included in the normalization with a weighting factor β. To achieve that, average power P of the beamforming/SDMA weights is determined over all subcarriers, as follows:

$$P = \frac{1}{{N}_{c} {N}_{tx}} {\sum }_{n = 1}^{{N}_{c}} {\sum }_{p = 1}^{{N}_{tx}} {\sum }_{q = 1}^{{N}_{ss}} {\vert {w}_{pq } ( n ) \vert}^{2} , \qquad ( 24 )$$

Therefore, in the FPRPSN method, the beamforming/SDMA weights W(n) may be normalized, as follows:

$${w}_{q}^{′} ( n ) = \frac{\sqrt{{P}_{pref}}}{\sqrt{β P + ( 1 - β ) \frac{{N}_{ss}}{{N}_{tx}} {\sum }_{p = 1}^{{N}_{ts}} {\vert {w}_{pq} ( n ) \vert}^{2} }} {w}_{q} ( n ) , \qquad ( 25 )$$

where w_{q}(n) represents the q^{th} column of W(n). Note that for β=0, the result is per-receiver per-subcarrier normalization, while β=1 represents overall normalization of all tones to a preferred output level.

For certain embodiments, the beamforming/SDMA weights may only be normalized per receiver. This method is called Flexible Per-Receiver Normalization (FPRN), and may be performed by calculating an average power of the beamforming/SDMA weights per receiver over all subcarriers, as follows:

$$s ( q ) = \frac{{N}_{ss}}{{N}_{c} {N}_{tx}} {\sum }_{n = 1}^{{N}_{c}} {\sum }_{p = 1}^{{N}_{tx}} {\vert {w}_{pq} ( n ) \vert}^{2} . \qquad ( 26 )$$

The beamforming/SDMA weights may then be normalized per receiver, as follows:

$${w}_{q}^{′} ( n ) = \frac{\sqrt{{P}_{pref}}}{\sqrt{( 1 - β ) s ( q ) + \frac{β}{{N}_{ss}} {\sum }_{q = 1}^{{N}_{ss}} s ( q )}} {w}_{q} ( n ) . \qquad ( 27 )$$

In this case, β=0 represents pure Per-Receiver Normalization (PRN) and β=1 represents average normalization to a preferred output level. Note that:

$$\frac{1}{{N}_{ss}} {\sum }_{q = 1}^{{N}_{ss}} s ( q ) = P . \qquad ( 28 )$$

For certain embodiments, the Flexible Per-Transmitter Normalization (FPTN) may be used by determining the average power of the beamforming/SDMA weights per transmitter over all subcarriers, as follows:

$$s ( p ) = \frac{1}{{N}_{c}} {\sum }_{n = 1}^{{N}_{c}} {\sum }_{q = 1}^{{N}_{ss}} {\vert {w}_{pq} ( n ) \vert}^{2} . \qquad ( 29 )$$

Then, normalizing the beamforming/SDMA weights per transmitter, as follows:

$${w}_{pq}^{′} ( n ) = \frac{\sqrt{{P}_{pref}}}{\sqrt{( 1 - β ) s ( p ) + \frac{β}{{N}_{tx} } {\sum }_{p = 1}^{{N}_{tx}} s ( p )}} {w}_{pq} ( n ) . \qquad ( 30 )$$

where β=0 results in pure Per-Transmitter Normalization (PTN) and β=1 results in normalization over all of the tones to a preferred output level.

For certain embodiments, in addition to most of the normalization techniques described in this section, the beamforming/SDMA weights may be normalized to the strongest transmission or each transmitter may be normalized.

Several methods were proposed in this document for calculating beamforming weights when the number of spatial streams to a destination is less than the number of receive antennas of the destination. In addition, methods were proposed for calculating SDMA weights for SDMA transmission.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, operations 500, 700 and 800 illustrated in FIGS. 5, 7 and 8 all correspond to means-plus-function blocks 500A, 700A and 800A illustrated in FIGS. 5A, 7A and 8A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to embodiments of the present disclosure, other and further embodiments of the disclosure may be devised without departing from the basic scope thereof, and the scope thereof is determined by the claims that follow.

1. A method for wireless communications, comprising:
estimating a channel matrix corresponding to a channel between a transmitter and a receiver;
selecting one or more spatial dimensions of the channel matrix so that number of spatial streams assigned to the receiver is less than number of receive antennas at the receiver;
calculating one or more beamforming weights based on the selected spatial dimensions; and
transmitting to the receiver using the beamforming weights.

2. The method of claim 1, further comprising:
normalizing the beamforming weights.

3. The method of claim 1, wherein calculating the one or more beamforming weights comprises:
calculating the beamforming weights based on minimum mean square error (MMSE) algorithm.

4. The method of claim 1, wherein calculating the one or more beamforming weights comprises:
calculating the beamforming weights based on minimum mean square error (MMSE) Average Receive Selection based on Power (ARSP) method.

5. The method of claim 1, wherein calculating the one or more beamforming weights comprises:
calculating the beamforming weights based on singular value decomposition (SVD) minimum mean square error (MMSE) method.

6. The method of claim 2, wherein normalizing the beamforming weights comprises:
normalizing the beamforming weights based on a Flexible Per-Subcarrier Normalization (FPSN) method.

7. The method of claim 1, wherein the transmitter utilizes orthogonal frequency division multiplexing (OFDM) technology.

8. The method of claim 1, wherein the transmitter operates in compliance with the Institute of Electrical and Electronics Engineers (IEEE) 802.11n standard.

9. A method for wireless communications, comprising:
estimating one or more channel matrices corresponding to channels between a transmitter and one or more receivers;
calculating one or more spatial division multiple access (SDMA) weights utilizing the channel matrices;
normalizing the SDMA weights; and
transmitting to the receivers using the SDMA weights.

10. The method of claim 9, wherein calculating the SDMA weights comprises:
calculating the SDMA weights using a minimum mean square error (MMSE) algorithm.

11. The method of claim 9, wherein normalizing the SDMA weights comprises:
normalizing the SDMA weights based on a Flexible Per-Subcarrier Normalization (FPSN) method.

12. The method of claim 9, wherein calculating the SDMA weights comprises:
calculating the SDMA weights based on a Block Diagonalization (BD) with MMSE equalization method.

13. The method of claim 9, wherein calculating the SDMA weights comprises:
performing spatial expansion for the receiver if number of spatial streams for the receiver is less than number of receive antennas at the receiver; and
calculating the SDMA weights using the minimum mean square error (MMSE) algorithm.

14. The method of claim 9, wherein the transmitter utilizes orthogonal frequency division multiplexing (OFDM) technology.

15. The method of claim 9, wherein the transmitter operates in compliance with the Institute of Electrical and Electronics Engineers (IEEE) 802.11n standard.

16. A method for wireless communications, comprising:
estimating one or more channel matrices corresponding to channels between a transmitter and one or more receivers;
selecting one or more spatial dimensions of the channel matrices so that number of spatial streams assigned to the receivers corresponding to the channel matrices are less than number of receive antennas at the receivers;
calculating one or more spatial division multiple access (SDMA) weights based on the selected spatial dimensions; and
transmitting to the receivers using the SDMA weights.

17. The method of claim 16, wherein calculating the SDMA weights comprises:
calculating the SDMA weights using a minimum mean square error (MMSE) algorithm.

18. The method of claim 16, wherein calculating the SDMA weights comprises:
calculating the SDMA weights based on a Block Diagonalization (BD) with MMSE equalization method.

19. The method of claim 16, further comprising:
normalizing the SDMA weights.

20. An apparatus for wireless communications, comprising:
logic for estimating a channel matrix corresponding to a channel between a transmitter and a receiver;
logic for selecting one or more spatial dimensions of the channel matrix so that number of spatial streams assigned to the receiver is less than number of receive antennas at the receiver;
logic for calculating one or more beamforming weights based on the selected spatial dimensions; and
logic for transmitting to the receiver using the beamforming weights.

21. The apparatus of claim 20, further comprising:
logic for normalizing the beamforming weights.

22. The apparatus of claim 20, wherein the logic for calculating the one or more beamforming weights comprises:
logic for calculating the beamforming weights based on minimum mean square error (MMSE) algorithm.

23. The apparatus of claim 20, wherein the logic for calculating the one or more beamforming weights comprises:
logic for calculating the beamforming weights based on minimum mean square error (MMSE) Average Receive Selection based on Power (ARSP) method.

24. The apparatus of claim 20, wherein the logic for calculating the one or more beamforming weights comprises:
logic for calculating the beamforming weights based on singular value decomposition (SVD) minimum mean square error (MMSE) method.

25. The apparatus of claim 21, wherein the logic for normalizing the beamforming weights comprises:
logic for normalizing the beamforming weights based on a Flexible Per-Subcarrier Normalization (FPSN) method.

26. The apparatus of claim 20, wherein the transmitter utilizes orthogonal frequency division multiplexing (OFDM) technology.

27. The apparatus of claim 20, wherein the transmitter operates in compliance with the Institute of Electrical and Electronics Engineers (IEEE) 802.11n standard.

28. An apparatus for wireless communications, comprising:
logic for estimating one or more channel matrices corresponding to channels between a transmitter and one or more receivers;
logic for calculating one or more spatial division multiple access (SDMA) weights utilizing the channel matrices;
logic for normalizing the SDMA weights; and
logic for transmitting to the receivers using the SDMA weights.

29. The apparatus of claim 28, wherein the logic for calculating the SDMA weights comprises:
logic for calculating the SDMA weights using a minimum mean square error (MMSE) algorithm.

30. The apparatus of claim 28, wherein the logic for normalizing the SDMA weights comprises:
logic for normalizing the SDMA weights based on a Flexible Per-Subcarrier Normalization (FPSN) method.

31. The apparatus of claim 28, wherein the logic for calculating the SDMA weights comprises:
logic for calculating the SDMA weights based on a Block Diagonalization (BD) with MMSE equalization method.

32. The apparatus of claim 28, wherein the logic for calculating the SDMA weights comprises:
logic for performing spatial expansion for the receiver if number of spatial streams for the receiver is less than number of receive antennas at the receiver; and
logic for calculating the SDMA weights using the minimum mean square error (MMSE) algorithm.

33. The apparatus of claim 28, wherein the transmitter utilizes orthogonal frequency division multiplexing (OFDM) technology.

34. The apparatus of claim 28, wherein the transmitter operates in compliance with the Institute of Electrical and Electronics Engineers (IEEE) 802.11n standard.

35. An apparatus for wireless communications, comprising:
logic for estimating one or more channel matrices corresponding to channels between a transmitter and one or more receivers;
logic for selecting one or more spatial dimensions of the channel matrices so that number of spatial streams assigned to the receivers corresponding to the channel matrices are less than number of receive antennas at the receivers;
logic for calculating one or more spatial division multiple access (SDMA) weights based on the selected spatial dimensions; and
logic for transmitting to the receivers using the SDMA weights.

36. The apparatus of claim 35, wherein the logic for calculating the SDMA weights comprises:
logic for calculating the SDMA weights using a minimum mean square error (MMSE) algorithm.

37. The apparatus of claim 35, wherein the logic for calculating the SDMA weights comprises:
logic for calculating the SDMA weights based on a Block Diagonalization (BD) with MMSE equalization method.

38. The apparatus of claim 35, further comprising:
logic for normalizing the SDMA weights.

39. An apparatus for wireless communications, comprising:
means for estimating a channel matrix corresponding to a channel between a transmitter and a receiver;
means for selecting one or more spatial dimensions of the channel matrix so that number of spatial streams assigned to the receiver is less than number of receive antennas at the receiver;
means for calculating one or more beamforming weights based on the selected spatial dimensions; and
means for transmitting to the receiver using the beamforming weights.

40. An apparatus for wireless communications, comprising:
means for estimating one or more channel matrices corresponding to channels between a transmitter and one or more receivers;
means for calculating one or more spatial division multiple access (SDMA) weights utilizing the channel matrices;
means for normalizing the SDMA weights; and
means for transmitting to the receivers using the SDMA weights.

41. An apparatus for wireless communications, comprising:
means for estimating one or more channel matrices corresponding to channels between a transmitter and one or more receivers;
means for selecting one or more spatial dimensions of the channel matrices so that number of spatial streams assigned to the receivers corresponding to the channel matrices are less than number of receive antennas at the receivers;
means for calculating one or more spatial division multiple access (SDMA) weights based on the selected spatial dimensions; and
means for transmitting to the receivers using the SDMA weights.

42. A computer-program product for wireless communications, comprising a computer readable medium having instructions stored thereon, the instructions being executable by one or more processors and the instructions comprising:
instructions for estimating a channel matrix corresponding to a channel between a transmitter and a receiver;
instructions for selecting one or more spatial dimensions of the channel matrix so that number of spatial streams assigned to the receiver is less than number of receive antennas at the receiver;
instructions for calculating one or more beamforming weights based on the selected spatial dimensions; and
instructions for transmitting to the receiver using the beamforming weights.

43. A computer-program product for wireless communications, comprising a computer readable medium having instructions stored thereon, the instructions being executable by one or more processors and the instructions comprising:
instructions for estimating one or more channel matrices corresponding to channels between a transmitter and one or more receivers;
instructions for calculating one or more spatial division multiple access (SDMA) weights utilizing the channel matrices;
instructions for normalizing the SDMA weights; and
instructions for transmitting to the receivers using the SDMA weights.

44. A computer-program product for wireless communications, comprising a computer readable medium having instructions stored thereon, the instructions being executable by one or more processors and the instructions comprising:
instructions for estimating one or more channel matrices corresponding to channels between a transmitter and one or more receivers;
instructions for selecting one or more spatial dimensions of the channel matrices so that number of spatial streams assigned to the receivers corresponding to the channel matrices are less than number of receive antennas at the receivers;
instructions for calculating one or more spatial division multiple access (SDMA) weights based on the selected spatial dimensions; and
instructions for transmitting to the receivers using the SDMA weights.
